(19) United States
(12) Patent Application Publication
(10) Pub. No.: US 2012/0290445 A1
(43) Pub. Date: Nov. 15, 2012

(54) DELEGATED APPLICATION AUTHORIZATION WITH INLINE PURCHASE

(75) Inventors: Adam D. Wilson, Seattle, WA (US); Viral Shah, Bothel, WA (US); Elisa Flasko, Duvall, WA (US)

(73) Assignee: MICROSOFT CORPORATION, Redmond, WA (US)

(21) Appl. No.: 13/230,300

(22) Filed: Sep. 12, 2011

Related U.S. Application Data
(60) Provisional application No. 61/484,063, filed on May 9, 2011.

(51) Int. Cl. G06Q 30/00

(52) U.S. Cl. 705/27.1

(57) ABSTRACT

Methods, systems, and computer program products are provided for delegating authorization to applications to access resources. An application operates in a computing device of a user. The user is navigated from the application to an authorization interface in response to the application determining a need for a resource of a resource repository. The user is enabled to register with the resource repository if the user is determined to not be registered with the resource repository. A resource available at the resource repository designated to be used in the application is determined The user is enabled to purchase a subscription to the resource if the user is determined to not have a subscription to the resource. The application is authorized to use the resource. The user is navigated back to the application. The application is enabled to use the resource associated with the subscription.

This application claims the benefit of U.S. Provisional Application No. 61/484,063, filed on May 9, 2011, which is incorporated by reference herein in its entirety.

### BACKGROUND

An application is software that runs in a computer system, and is implemented to perform one or more tasks. Various types of applications exist, including office suite applications, desktop applications, mobile applications, web applications, etc. Office suite applications include various types of productivity enhancing applications, such as word processing applications, spreadsheet applications, presentation applications, etc. Desktop applications include various types of applications that configured to operate in computer desktops (e.g., of desktop computers), including some office suite applications, desktop widgets or gadgets (interactive tools that typically provide single purpose services, such as news streaming, providing the current weather, showing current stock quotes, etc.), etc. Mobile applications include various types of applications that operate in mobile, handheld devices such as smart phones, tablet computers, portable media players, personal digital assistants (PDAs), etc. Examples of mobile applications include “Apps” that run on smart phones and/or tablet computers such as Apple® iPhones®, Apple iPads™, smart phones and tablet computers that incorporate the Google Android™ platform, smart phones and tablet computers that incorporate Microsoft Windows® operating systems (e.g., Windows 7 phones, etc.), etc. Web applications (also known as a “web apps” or “webapps”) are applications that are accessible over a network such as the Internet or an intranet, and may be hosted in a web browser that renders the application.

Applications often need to interact with third-party services to deliver part of their functionality. Many of these third-party services require account information from users or other data related to the user of the application. In many cases, an application must request authorization to access specific data stored in the user's account on the third-party service. Before an application can access data from a third-party service, a user has to grant consent to the service to act on their behalf. After the user grants consent to the service to act on their behalf, applications can access the service for the data. This delegation of authorization to the service is performed before the user can even use the application.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided for delegating authorization to applications to access resources. Developers are enabled to register applications with a resource repository and to designate resources of the resource repository to be used by the applications. Furthermore, applications are enabled to be granted authorization to access the designated resources. During operation of the application, the application may be navigated to the resource repository to be granted access to the data by a user of the application. The user may be enabled to subscribe to the designated resources if such the user does not already have such a subscription. After authorization to access the resources is granted to the application, the application may resume its normal operations, and may access the resources as desired. As such, the user does not have to pre-delegate authorization to the application (prior to operation of the application).

In one method implementation, a developer is enabled to register an application with a resource repository. The developer is enabled to designate a resource at the resource repository to be used in the application. In a system implementation, a resource authorization system resides in a server. The resource authorization system is configured to provide a developer interface. The developer interface enables a developer to register an application with a resource repository. The developer interface further enables the developer to designate a resource at the resource repository to be used in the application.

In another method implementation in a server, an application operates in a computing device of a user. The user is navigated from the application to an authorization interface provided by the server in response to the application determining a need for a resource of a resource repository. The user is enabled to register with the resource repository if the user is determined to not be registered with the resource repository. A resource available at the resource repository designated to be used in the application is determined The user is enabled to purchase a subscription to the resource if the user is determined to not have a subscription to the resource. The application is authorized to use the resource. The user is navigated back to the application. The application is enabled to use the resource associated with the subscription.

In another system implementation, a resource authorization system resides in a server. The resource authorization system includes an authorization interface module, a user registration module, a resource determiner, and a subscription purchasing module. The authorization interface module navigates a user from an application executing in a computing device to an authorization interface in response to the application determining a need for a resource of a resource repository. The user registration module enables the user to register with the resource repository if the user is determined to not be registered with the resource repository. The resource determiner determines a resource available at the resource repository designated to be used in the application. The subscription purchasing module enables the user to purchase a subscription to the resource if the user is determined to not have a subscription to the resource. The authorization interface module authorizes the application to use the subscribed resource and enables the user to be navigated back to the application. The application is enabled to use the subscribed resource.

Computer program products are also described herein for enabling developers to register applications with a resource repository and to designate resources of the resource repository to be used by the applications. Furthermore, computer program products are described herein for enabling applications to be granted authorization to access the designated resources. Computer program products are also described herein for additional embodiments.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 shows a block diagram of an application resource authorization environment, according to an example embodiment.

FIG. 2 shows a block diagram of a resource authorization system configured to enable a developer to register an application with a resource repository that supplies resources, according to an example embodiment.

FIG. 3 shows a flowchart providing a process for registering an application with a resource repository that supplies resources, according to an example embodiment.

FIG. 4 shows a flowchart providing a process for authorizing an application to access resources at a resource repository, according to an example embodiment.

FIG. 5 shows a block diagram of a resource authorization system configured to enable an application to access resources at a resource repository, according to an example embodiment.

FIG. 6 shows a block diagram of a computing device that displays an authorization interface, according to an example embodiment.

FIG. 7 shows a block diagram of an authorization interface that enables a user to sign into an account to enable access by an application to resources at a resource repository, according to an example embodiment.

FIG. 8 shows a flowchart providing a process for enabling a user to sign into an account to determine whether the user is registered with a resource repository, according to an example embodiment.

FIG. 9 shows a block diagram of an authorization interface that enables a user to select and pay for resource bundles at a resource repository, according to an example embodiment.

FIG. 10 shows a flowchart providing a process for enabling a user to select and pay for resource bundles at a resource repository, according to an example embodiment.

FIG. 11 shows a block diagram of a payment interface that provides a sequence of interfaces that enable a user to pay for resource bundles at a resource repository, according to an example embodiment.

FIG. 12 shows a block diagram of an example computer that may be used to implement embodiments of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments of the present invention are described as follows. It noted that any section/subsection headings provided herein are not intended to be limiting. Embodiments are described throughout this document, and any type of embodiment may be included under any section/subsection.

### II. Example Embodiments

Embodiments relate to techniques for providing applications with authorization grant to resources that require payment. In embodiments, during execution of an application, it may be determined that a resource of a resource repository is needed by the application. The resource may be data or other type of resource that is provided by a third-party service and that is made accessible at the resource repository. The application may redirect a user to an authorization interface that enables the user to register with the resource repository, if not already registered, and enables the user to pay for a subscription to the resource. After the subscription is purchased, the application may resume operation, and may be granted access to the resource at the resource repository for use in any manner.

As such, example embodiments may enable/provide one or more of: authorization for a resource that requires payment; an authorization process or flow by where a user grants authorization to an application to a resource that requires payment, whereby the user purchases the resource as a part of the authorization flow; an authorization flow that may be a proprietary or a standard authorization flow (e.g., the OAuth (open standard of authorization) user consent flow); and/or compensation to a developer for resources purchased as a result of their authorization flow being accessed by users and applications.

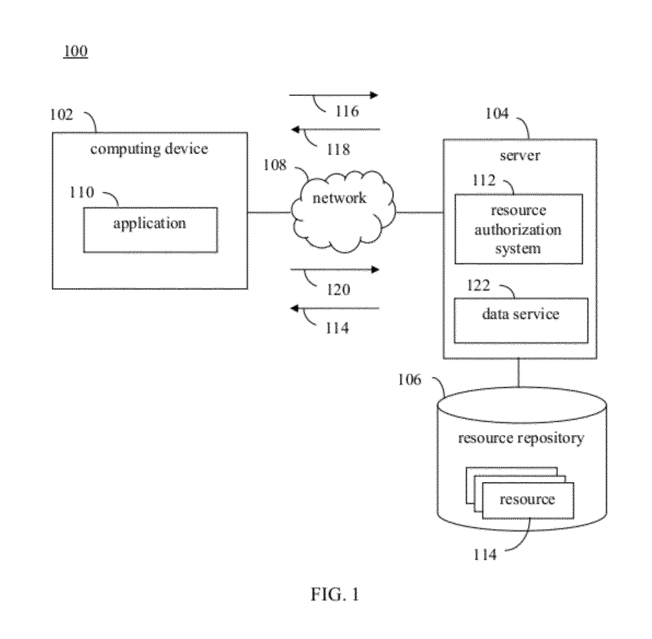

Such embodiments may be implemented in a variety of environments. For instance, FIG. 1 shows a block diagram of a resource authorization environment 100, according to an example embodiment. As shown in FIG. 1, environment 100 includes a computing device 102, a server 104, a resource repository 106, and a network 108. As shown in FIG. 1, computing device 102 includes an application 110, and server 104 includes a resource authorization system 112 and a data service 122. Environment 100 is described as follows.

Computing device 102 may be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a mobile phone (e.g., a cell phone, a smart phone such as an Apple iPhone, a Google Android™ phone, a Microsoft Windows® phone, etc.), or other type of mobile device. Server 104 may be implemented in one or more computer systems, including one or more servers, which may be any type of computing device described herein or otherwise known that is capable of enabling the corresponding functionality described herein.

Computing device 102 and server 104 are communicatively coupled by network 108. Network 108 may include one or more communication links and/or communication networks, such as a PAN (personal area network), a LAN (local area network), a WAN (wide area network), or a combination of networks, such as the Internet. Computing device 102 and server 104 may be communicatively coupled to network 108 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

A single computing device 102 is shown in FIG. 1 for purposes of illustration. However, any number of computing devices 102 may be present in environment 100, including tens, hundreds, thousands, and even greater numbers of computing devices 102. Each computing device may operate one or more corresponding applications. As shown in FIG. 1, resource repository 106 is coupled to computing device 102. Resource repository 106 includes resources 114, which may be data (e.g., datasets) or other types of resources. Resource repository 106 may have the format of a database or other format, and may include one or more of any type of storage mechanism to store resources 114, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

Application 110 is a software application that executes/operates in computing device 102. For example, application 110 may be an office suite application, desktop application, mobile application, web application, etc. Office suite applications include various types of productivity enhancing applications, such as word processing applications, spreadsheet applications, presentation applications, etc. Desktop applications include various types of applications that configured to operate in computer desktops (e.g., of desktop computers), including some office suite applications, desktop widgets or gadgets (interactive tools that typically provide single purpose services, such as news streaming, providing the current weather, showing current stock quotes, etc.), etc. Mobile applications include various types of applications (e.g., “Apps”) that operate in mobile, handheld devices such as smart phones, tablet computers, portable media players, personal digital assistants (PDAs), etc. Web applications (also known as a “web apps” or “webapps”) are applications that are accessible over a network such as the Internet or an intranet, and may be hosted in a web browser that renders the application. Example applications include social networking applications, navigational assistance applications (e.g., mapping applications, restaurant locating applications, traffic applications, etc.), gaming applications, financial planning applications, etc.

Resource authorization system 112 operating in server 104 enables resources of resource repository 106 to be provided to/accessed by applications such as application 110. For instance, resource authorization system 112 may enable developers to register their applications with resource repository 106. In this manner, the resources of resource repository 106 that are used by the applications during operation may be indicated at resource authorization system 112 (e.g., in storage associated with server 104). Subsequently, during operation of an application, such as application 110, application 110 may need the resource(s) registered for the application with resource repository 106, such as resource 114, and may obtain authorization to access the resource(s) from resource authorization system 112.

For instance, as shown in FIG. 1, application 110 may provide an authorization request 116 to resource authorization system 112, such as by traversing a link (e.g., a uniform resource locator) to an authorization interface provided by resource authorization system 112. As shown in FIG. 1, request 116 is transmitted from computing device 102 in a first communication signal through network 108 to be received by resource authorization system 112 at server 104. The first communication signal may be transmitted in any form. In response to request 116, resource authorization system 112 provides authorization to application 110 to access resource 114 through an inline authorization process that occurs during operation of application 110. For instance, during the inline authorization process, operation of application 110 may be suspended (e.g., paused), and resource authorization system 112 may authenticate a user of application 110. This include setting up a user account associated with resource repository 106 for the user, if the user does not already have such an account. Furthermore, during the inline authorization process, resource authorization system 112 determines whether the user has a subscription to resource 114. If the user does not have a subscription to resource 114, resource authorization system 112 may enable the user to purchase such a subscription. Once it is determined that the user has a subscription to resource 114, resource authorization system 112 may authorize application 110 to access resource 114.

As shown in FIG. 1, resource authorization system 112 may transmit an authorization indication 118 from server 104 in a second communication signal through network 108 to be received by application 110 at computing device 102. The second communication signal may be transmitted in any form. Authorization indication 118 indicates to application 110 that resource 114 may be accessed. For instance, authorization indication 118 may include an access code, an access link, or other authorization information that application 110 may subsequently use to access resource 114. Application 110 may subsequently transmit a resource request 120 from computing device 102 in a third communication signal through network 108 to be received by data service 122 at server 104. Data service 122 is configured to provide resource 114 to application 110 in response to resource request 120. For instance, data service 122 may be configured to access resource repository 106 as a database, or may be configured in any other manner In an embodiment, resource request 120 may identify resource 114, and may include any authorization information provided by resource authorization system 112. In such an embodiment, data service 122 may provide resource 114 in response to receiving resource request 120. As shown in FIG. 1, data service 122 may transmit resource 114 from server 104 in a fourth communication signal through network 108 to be received by application 110 at computing device 102. Application 110 may use resource 114 in any manner, depending on a configuration of application 110 and resource 114. Furthermore, application 110 may access resource 114 as often as desired, depending on the type of subscription (e.g., which may provide for a particular number of permitted accesses, etc.).

Note that in an alternative embodiment, resource 114 may be transmitted to application 110 after resource authorization system 112 provides authorization for application 110 to access resource 114 without application 120 transmitting resource request 120. Furthermore, in an embodiment, data service 122 may be integrated in resource authorization system 112, and thus may not be separate from resource authorization system 112 as shown in FIG. 1. In still another embodiment, data service 122 may be included in a second server that is separate from server 104. Resource repository 106 may be coupled to the second server, and resources 114 may be provided from data service 122 in the second server to application 110 in response to resource request 120 being received at the second server.

Resource authorization system 112 may perform its functions in various ways, in embodiments. Numerous exemplary embodiments of resource authorization system 112 and further embodiments for authorizing applications to use resources are described as follows.

### A. Example Embodiments for Registering Applications to Access Resources

According to an example embodiment, a developer is enabled to register their application with a resource repository that is accessible over a network (e.g., the Internet). The developer determines which data a user must have or optionally could have and use in the developer's application. This data is associated with the application registration at the resource repository, so that in subsequent operation of the application by users, the data may be accessed by the application at the resource repository (if authorization to access the data is granted to the application).

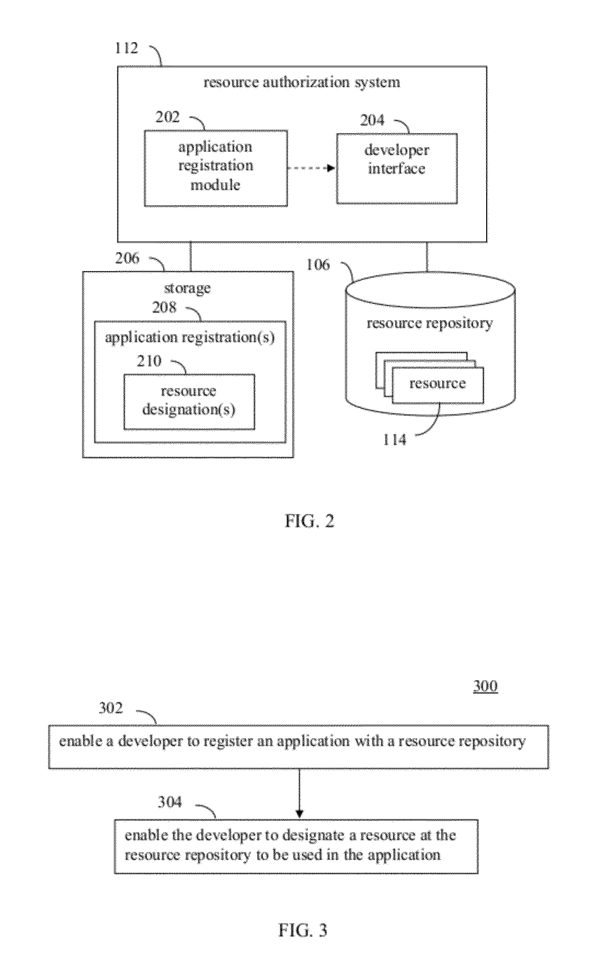

For instance, FIG. 2 shows a block diagram of resource authorization system 112 configured to enable a developer to register an application with resource repository 106, according to an example embodiment. As shown in FIG. 2, resource authorization system 112 includes an application registration module 202, and resource repository 106 is present. Furthermore, storage 206 is coupled to resource authorization system 112. In an embodiment, application registration module 202 may enable a developer to register application 110 (of FIG. 1) with resource repository 106. For example, as shown in FIG. 2, application registration module 202 may generate/provide a developer interface 204 that the developer may interact with to register application 110. The developer may be a developer of application 110, and during the registration, may indicate one or more resources of resource repository 106 that may be used by application 110 during its operation.

Application registration module 202 of FIG. 2 may operate in various ways to perform its functions. For instance, FIG. 3 shows a flowchart 300 providing a process for registering an application with a resource repository that supplies resources, according to an example embodiment. Flowchart 300 is described as follows with reference to FIG. 2. Further structural and operational embodiments will be apparent to persons skilled in the relevant art(s) based on the following discussion regarding flowchart 300.

Flowchart 300 begins with step 302. In step 302, a developer is enabled to register an application with a resource repository. For example, in an embodiment, as described above, application registration module 202 may generate developer interface 204, which may be displayed to a developer. The developer may interact with developer interface 204 to register application 110 with resource repository 106. The developer may access developer interface 204 by navigating to a website associated with application registration module 202, or may access developer interface 204 in other manner. The developer may access developer interface 204 at server 104, or may access developer interface 204 at a computing device that is separate from server 104. Application registration module 202 may provide developer interface 204 in any manner.

For example, in an embodiment, application registration module 202 may be accessible over a network (e.g., network 106 of FIG. 1), and may generate developer interface 204 for display in a web browser (e.g., as HTML (hypertext markup language), XML (extensible markup language), or other browser suitable language) or other type of user interface at a computing device used by the developer. In such an example, developer interface 204 may include a Tillable form (with form entry blanks) and/or one or more user interface elements (e.g., radio buttons, check boxes, etc., in one or more interface windows) to enable the developer to register application 110. For instance, developer interface 204 may request that the developer provide one or more of a name of the developer, an organization (e.g., a business, etc.) with which the developer is associated, contact information (e.g., a phone number, an email address, etc.), a client identifier, a name of the application, a redirection network address (e.g., a uniform resource indicator (URI) or uniform resource locator (URL), etc.) for the application, a description of the application, etc. In an embodiment, the developer may create a user account by interacting with developer interface 204. One or more applications of the developer may be associated with the user account, and may be managed through the user account. For instance, one or more of the name of the developer, a name of an organization with which the developer is associated, contact information for the developer, and/or other information may be provided to create the user account. In another embodiment, a user account is not needed.

Application registration module 202 is configured to receive the information input to developer interface 204 by the developer, and to store a registration of the application (e.g., in storage associated with application registration module 202) that includes the input information. For example, as shown in FIG. 2, storage 206 may include one or more application registrations 208 that each correspond to an application registered with application registration module 202 by a developer (or other user).

Referring back to FIG. 3, in step 304, the developer is enabled to designate a resource at the resource repository to be used in the application. For instance, in an embodiment, application registration module 202 may generate developer interface 204, which may be displayed to a developer, to enable the developer to designate one or more resources, such as resource 114, to be used by application 110 when operating. Developer interface 204 may enable the developer to select one or more resources in various ways, including by enabling the developer to select resources from a displayed list, by enabling the developer to perform keyword queries or searches on available resources and selecting the resource(s) in the search results, etc. Developer interface 204 may enable the developer to select entire resource records (having multiple data fields), to select particular data fields, etc.

Any types and quantities of resources may be present at resource repository 106 that may be designated for used in applications by developers. Examples of such resources include data/datasets such as demographic data (e.g., collected by social networks, email account services, merchants, etc.), purchasing data (e.g., collected by merchants, etc.), census data (e.g., provided by a government, etc.), geographical data (e.g., city data, state data, street-level data, etc., collected by mapping services, etc.), traffic data, real estate data (e.g., collected by real estate services), etc. These examples are provided for purposes of illustration, and are not intended to be limiting. Many types of data are available, and are applicable to the embodiments described herein.

Application registration module 202 is configured to receive the indications of the designated resource(s) input to developer interface 204 by the developer, and to store the indications of the designated resource(s) with the registration of the application. For example, as shown in FIG. 2, one or more resource designations 210 may be stored in storage 206 with each application registration of application registrations 206.

As a result of application registration module 202 enabling the developer to register an application and designate resources used by the application, when users subsequently operate the application in computing devices, the operating application may request the designated resources from resource authorization system 112 at server 104. If a user has granted the application authorization to request the designated resources from resource authorization system 112, the application may receive the designated resources during operation of the application. If the user has not yet granted the application authorization to request the designated resources from resource authorization system 112, during operation of the application, the user may be enabled to grant the application authorization to access the designated resources, and may purchase subscriptions to the designated resources if needed, as described above. Further embodiments for such granting of authorization and purchasing of resource subscriptions during inline operation of an application are described in the following subsection.

Note that to enable the application to request data from resource repository 106 (and to be granted authorization, etc.), the application may be configured to communicate with resource repository 106. For instance, computer code may be included in application 110 to enable communications with resource repository 106. For example, in an embodiment, the application may include a link (e.g., a URI, a URL, etc.) that navigates to a user interface associated with resource repository 106. The user interface enables a user to grant authorization to the application to access the designated resources, and to purchase a subscription to the designated resources if needed. Example embodiments for this authorization grant process are described in the following subsection.

Furthermore, in embodiments, the developer of application 110 may be enabled to generate revenue based on application 110 accessing the designated resources when being operated by users. For instance, in an embodiment, the developer may receive compensation each time a user using application 110 purchases a subscription to the designated resource for use by application 110. In this manner, the developer can generate additional income for developing application 110, can pay for the use of the designated resource, etc.

Note that storage 206 may include one or more of any type of storage mechanism, including a magnetic disc (e.g., in a hard disk drive), an optical disc (e.g., in an optical disk drive), a magnetic tape (e.g., in a tape drive), a memory device such as a RAM device, a ROM device, etc., and/or any other suitable type of storage medium.

### B. Example Embodiments for Applications Accessing Resources

According to an example embodiment, during execution of an application, it may be determined that a resource of a resource repository is needed by the application. The application may redirect a user to an authorization interface that enables the user to register with the resource repository, if not already registered, and may enable the user to pay for a subscription to the resource, if needed. The user delegates authorization to the application to access the resource at the resource repository. The application may resume operation, and may receive the resource from the resource repository for use/processing in any manner.

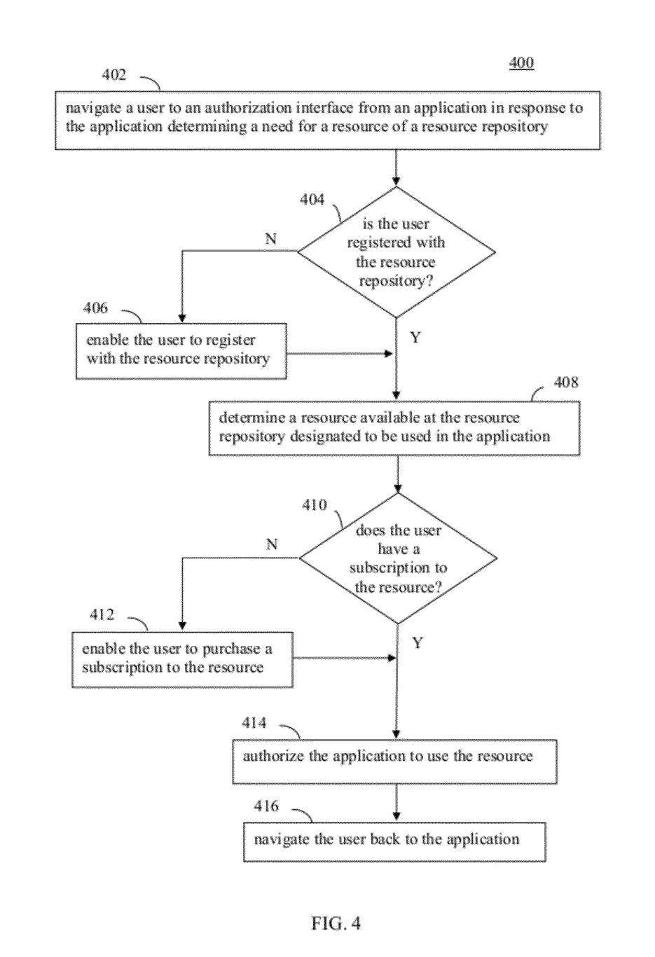

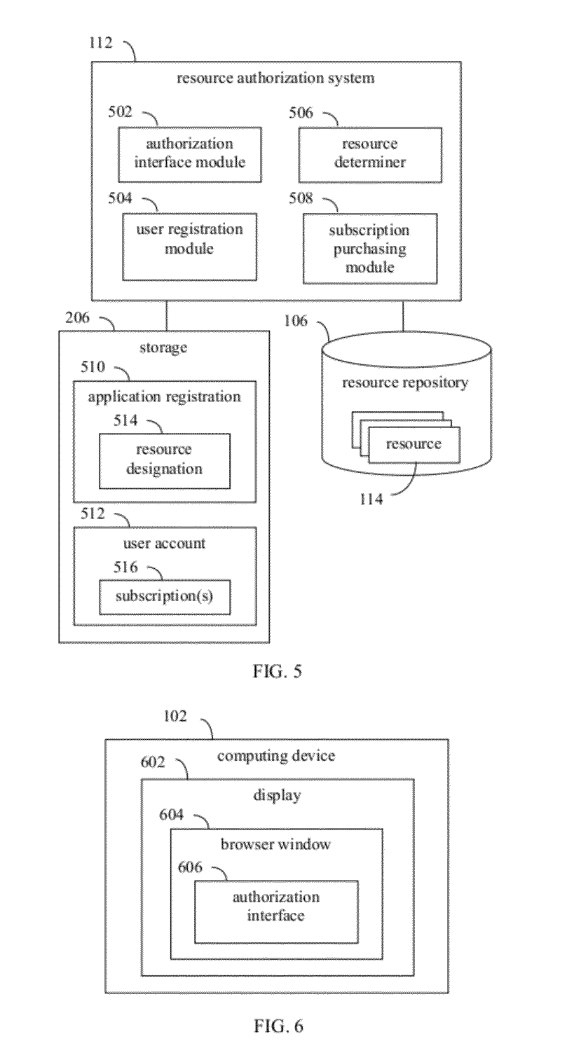

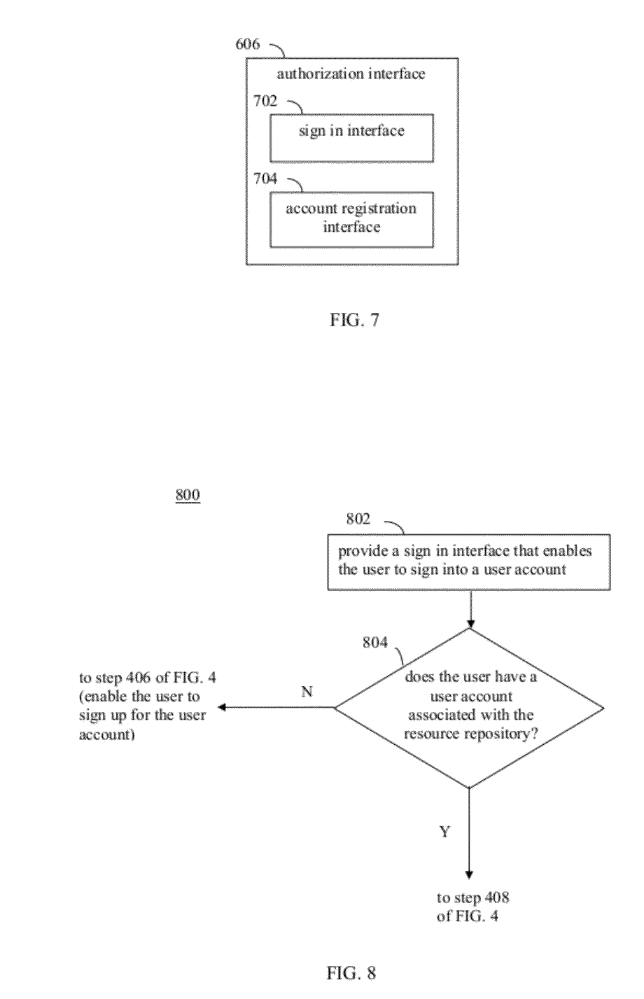

Applications may be granted authorization to access resources of a resource repository in various ways, in embodiments. For instance, FIG. 4 shows a flowchart 400 providing a process for authorizing an application to access resources at a resource repository, according to an example embodiment. Flowchart 400 is described as follows with reference to FIG. 5. FIG. 5 shows a block diagram of resource authorization system 112 configured to enable an application to access resources at a resource repository, according to an example embodiment. As shown in FIG. 5, resource authorization system 112 includes an authorization interface module 502, a user registration module 504, a resource determiner 506, and a subscription purchasing module 508. Furthermore, resource authorization system 112 is coupled to storage 206 and resource repository 106. Further structural and operational embodiments will be apparent to persons skilled in the relevant art(s) based on the following discussion regarding flowchart 400 and FIG. 5.

Flowchart 400 begins with step 402. In step 402, a user is navigated to an authorization interface from an application in response to the application determining a need for a resource of a resource repository. For example, in an embodiment, authorization interface module 502 of FIG. 5 may provide an authorization interface to computing device 102 (of FIG. 1) in response to application 110 determining a need for resource 114 of resource repository 106. The authorization interface is a user interface configured to enable the user of application 110 to grant authorization to application 110 to access resource 114 of resource repository 106.

For example, when the user uses application 110, application 110 may generate a URL (e.g., a user consent URL) that the user is navigated to (as described in the previous subsection). An authorization interface hosted by resource authorization system 112 (at server 104) and having an address of the URL, is provided to computing device 102 to be displayed to the user. The authorization interface may be interacted with by the user to grant authorization to application 110 to access resource 114 of resource repository 106.

For instance, FIG. 6 shows a block diagram of computing device 102 of FIG. 1 displaying an authorization interface 606, according to an example embodiment. As shown in FIG. 6, computing device 102 includes a display 602. Display 602 may be any suitable type of display device having a display screen, such as a cathode ray tube (CRT) display, a liquid crystal display (LCD) display, a light emitting diode (LED) display, a plasma display, or other display type. As shown in FIG. 6, a browser window 604 is displayed by display 602. Browser window 604 is a window generated by a web browser operating in computing device 102, such as Internet Explorer®, developed by Microsoft Corp. of Redmond, Wash., Mozilla Firefox®, developed by Mozilla Corp. of Mountain View, Calif., Google® Chrome developed by Google Inc. of Mountain View, Calif. As shown in FIG. 6, browser window 604 displays an authorization interface 606. Authorization interface 606 may be configured to enable the user of application 110 to grant authorization to application 110 to access resource 114 of resource repository 106.

For instance, authorization interface 606 may include a first web page that is retrieved by browser window 604 from authorization interface module 502 (e.g., over network 108 of FIG. 1) according to a user consent URL provided by application 110. Authorization interface 606 may include any number of one or more web pages that when displayed provide a user interface for enabling the user to grant authorization to application 110 to access resource 114. In such an embodiment, authorization interface 606 may be generated in browser window from suitable page code (e.g., HTML, XML, or other browser suitable language). Authorization interface 606 may include a fillable form and/or one or more user interface elements (in one or more interface windows) for interaction by a user.

Note that in other embodiments, an authorization interface may be provided to a user in a form other than as a web page to enable the user to grant authorization to application 110 to access resource 114, as would be known to persons skilled in the relevant art(s). For instance, a window that displays an authorization interface may be opened and displayed to the user (e.g., a new window, a window embedded in an existing window, etc.).

Operation proceeds from step 402 to step 404. In step 404, whether the user is registered with the resource repository is determined In embodiments, authorization interface module 502 may be configured to determine whether the user is registered with resource repository 106 in various ways. For instance, in one embodiment, authorization interface module 502 may determine whether the user has a user account associated with resource repository 114. In one embodiment, the user account may be a user account that is specific to resource repository 114. In another embodiment, the user account may be a user account that is not specific to resource repository 114, such as a general purpose user account or other type of user account (e.g., an email account with an email service, etc.), but with which a registration with resource repository 114 may be associated. Whether the user is registered with resource repository 114 may be determined based on the user account, as described below. If the user is determined to not be registered with the resource repository, operation proceeds from step 404 to step 406. For example, in such case, authorization interface module 502 may provide an instruction to user registration module 504 to enable the user to register for a user account. If the user is determined to be registered with the resource repository, operation proceeds from step 404 to step 408.

For instance, FIG. 7 shows a block diagram of authorization interface 606 configured to enable a user to sign into an account to enable access by application 110 to resource 114 at resource repository 106, according to an example embodiment. As shown in FIG. 7, authorization interface 606 includes a sign in interface 702. Sign in interface 702 may be a web page or other type of user interface. Sign in interface 702 includes a fillable form and/or other user interface elements, and enables the user to sign into a user account associated with resource repository 106, if the user has such a user account.

For instance, FIG. 8 shows a flowchart 800 providing a process for enabling a user to sign into an account to determine whether the user is registered with a resource repository, according to an example embodiment. For instance, in an embodiment, resource authorization system 112 of FIG. 5 may perform flowchart 800. Further structural and operational embodiments will be apparent to persons skilled in the relevant art(s) based on the following discussion regarding flowchart 800.

Flowchart 800 begins with step 802. In step 802, a sign in interface is provided that enables the user to sign into a user account. For instance, as described above, authorization interface module 502 (FIG. 5) may generate authorization interface 606 to include sign in interface 702. Sign in interface 702 is configured to enable a user to sign into a user account associated with resource repository 106 (e.g., by providing a user identifier, a password, and/or other information). Operation proceeds from step 802 to step 804.

In step 804, whether the user has a user account associated with the resource repository is determined. If the user is unable to sign in to the user account using sign in interface 702, the user may be determined to not be registered with the resource repository. In such case, as shown in FIG. 8, operation may proceed from step 804 to step 406 of FIG. 4, where the user may be enabled to sign up for a user account.

If the user is able to sign in to the user account using sign in interface 702 (e.g., by providing an account identifier, a password, etc.), the type of user account may indicate whether the user has a user account associated with resource repository 106. If the user account is specific to resource repository 106, authorization interface module 502 may determine that the user has a user account associated with resource repository 106 by virtue of the user being able to sign into the user account. In such case, operation may proceed from step 804 to step 408 of FIG. 4.

If the user account is not specific to resource repository 106, authorization interface module 502 may analyze the user account to determine whether it is associated with resource repository 106. In such case, authorization interface module 502 may identify the user based upon the user account, and may search parameters of the user account to determine whether a registration with resource repository 106 is associated with the user account. A parameter of the user account may indicate whether the user account is associated with resource repository 106. If the user account indicates that the user account is associated with resource repository 106, operation may proceed from step 804 to step 408 of FIG. 4. If the user account does not indicate that the user account is associated with resource repository 106, operation may proceed from step 804 to step 406 of FIG. 4.

Referring back to FIG. 4, in step 406, the user is enabled to register with the resource repository. In an embodiment, user registration module 504 may perform step 406. In one embodiment, to register with resource repository 106, the user may be enabled to sign up for a user account that is associated with resource repository 106. In another embodiment, to register with resource repository 106, the user may be enabled register an existing user account of the user with resource repository 106.

For example, as shown in FIG. 7, authorization interface 606 includes an account registration interface 704. Account registration interface 704 may be generated by user registration module 504 of FIG. 5. Account registration interface 704 may be a web page or other type of user interface. Account registration interface 704 may include a Tillable form and/or other user interface elements, and enables the user to register for a user account associated with resource registry 106 if the user does not have such a user account, or may enable the user to register an existing user account of the user with resource repository 106. To configure a new user account, account registration interface 704 may receive identifying information from the user, including a name, a user name (e.g., a sign in/login name), a password, etc. To register an existing user account of the user with resource repository 106, the user may be enabled to sign in to the user account using sign in interface 702, as described above, and may add a registration with resource repository 106 to the user account using account registration interface 704. For instance, account registration interface 704 may enable the user to select resource registry 106 from a list, or in any other manner, to be registered in the user account. Operation proceeds from step 406 to step 408.

In step 408, a resource available at the resource repository designated to be used in the application is determined For example, in an embodiment, resource determiner 506 shown in FIG. 5 may be configured to determine any resources of resource repository 106 used by application 110, including resource 114. For instance, in one embodiment, authorization request 116 received by resource authorization system 112 from application 110 may indicate the resources used by application 110. In such an embodiment, resource determiner 506 may determine the resources used by application 110 from authorization request 116. In another embodiment, resource determiner 506 may access the indications of the designated resource(s) stored with the registration of application 110 by application registration module 202, as described in the previous subsection. For instance, as shown in FIG. 5, an application registration 510 may be stored in storage 206. Application registration 510 may be a registration for application 110, and may be accessed to determine designated resources for application 110. As shown in FIG. 5, application registration 510 includes a resource designation 514, which may indicate resource 114 as a designated resource for application 110. Operation proceeds from step 408 to step 410.

In step 410, whether the user has a subscription to the resource is determined. For instance, in an embodiment, the user account of the user may indicate any subscriptions to resources of resource repository 106 held by the user. As such, resource determiner 506 may be configured to analyze the user account of the user to determine whether the user has a subscription to resource 114. For instance, as shown in FIG. 5, storage 206 may include user accounts for users, including a user account 512 for the user of application 110. Each user account may include one or more subscriptions to resources. For instance, as shown in FIG. 5, user account 512 includes subscription(s) 516, which indicate subscriptions to resources of resource repository 106 of the user (e.g., by resource identifiers). If the user is determined to not have a subscription to the resource, operation proceeds from step 410 to step 412. For example, in such case, authorization interface module 502 may provide an instruction to subscription purchasing module 508 to enable the user to purchase a subscription for the resource, which may be a subscription to have permanent access to the resource, or a limited time and/or use subscription to access the resource. For instance, a limited time subscription may enable access to the resource for a particular time period (e.g., a month, a year, etc.). A limited use subscription may enable the resource to be accessed a particular number of times (e.g., a one-time access, ten accesses, one hundred accesses, or other number of times). If the user is determined to have a subscription to the resource, operation proceeds from step 410 to step 414.

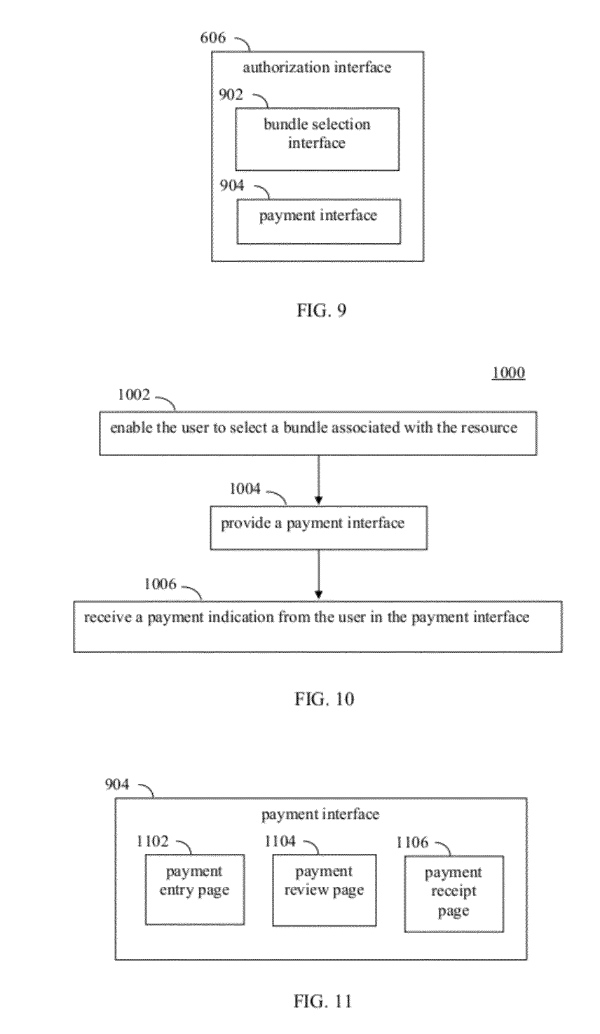

In step 412, the user is enabled to purchase a subscription to the resource. For instance, in an embodiment, subscription purchasing module 508 of FIG. 5 may be configured to enable the user to purchase a subscription to one or more resources, such as resource 114. For instance, FIG. 9 shows a block diagram of authorization interface 606 configured to enable a user to select and pay for resource bundles of resource repository 106, according to an example embodiment. As shown in FIG. 9, authorization interface 606 includes a bundle selection interface 902 and a payment interface 904. Bundle selection interface 902 and payment interface 904 may each be a web page (or may be combined in a web page) or other type of user interface. Bundle selection interface 902 may include a fillable form and/or other user interface elements, and enables the user to select one or more resources of resource repository 106 for purchase. Payment interface 904 may include a fillable form and/or other user interface elements, and enables the user to pay for the one or more resources selected using bundle selection interface 902.

Bundle selection 902 and payment interface 904 may be generated by subscription purchasing module 508 in any manner to enable selection and purchasing of resources. For instance, FIG. 10 shows a flowchart 1000 providing a process for enabling a user to select and pay for resource bundles at a resource repository, according to an example embodiment. For instance, in an embodiment, subscription purchasing module 508 of FIG. 5 may perform flowchart 1000. Further structural and operational embodiments will be apparent to persons skilled in the relevant art(s) based on the following discussion regarding flowchart 1000.

Flowchart 1000 begins with step 1002. In step 1002, the user is enabled to select a bundle associated with the resource. For example, in an embodiment, subscription purchasing module 508 may generate bundle selection interface 902 for display to the user in authorization interface 606. Bundle selection interface 902 may display one or more resources available at resource repository 106 for purchase, including resource 114. For instance, bundle selection interface 902 may display resources of resource repository 106 in any form. For instance, bundle selection interface 902 may enable the user to select resources from a displayed list, may enable the user to perform keyword queries or searches on available resources and to select the resource(s) in the search results, etc. Bundle selection interface 902 may enable the user to select entire resource records (having multiple data fields), to select particular data fields, etc. Furthermore, bundle selection interface 902 may enable the user to select “bundles” of a resource, which indicate a number of accesses by application 110 to resource repository 106 for the resource that are being paid for. For instance, a bundle may include 5, 10, 20, 50, or any other number of accesses by application 110 to resource repository 106 for resource 114. Such bundles made available by bundle selection interface 902 may be pre-created by the developer of application 110, may be configured by the user, or may be configured in other way. In this manner, developers may be enabled to create bundles of resources that work with their application and to market/describe these bundles in a manner that makes sense to their users (rather than how the original provider of the data resource may have intended for it to be described).

Bundle selection interface 902 may display a “purchase” button or other user interface that enable the selected resources (and optionally selected bundles) to be purchased according to steps 1004 and 1006. Operation proceeds from step 1002 to step 1004.

In step 1004, a payment interface is provided. For example, in an embodiment, subscription purchasing module 508 may generate payment interface 904 for display to the user in authorization interface 606. As described above, payment interface 904 may enable the user to pay for the one or more resources selected using bundle selection interface 902 in step 1002. Payment interface 904 may be configured in any manner to enable users to provide payment for resources, including displaying a single payment window, or a series of payment windows displayed one at a time in sequence.

For instance, FIG. 11 shows a block diagram of payment interface 904 providing a sequence of interfaces that enable a user to pay for resource bundles at a resource repository, according to an example embodiment. As shown in FIG. 11, payment interface 904 may include a payment entry page 1102, a payment review page 1104, and a payment receipt page 1106. In an embodiment, payment entry page 1102, payment review page 1104, and payment receipt page 1106 are displayed one at a time in series to enable a user to pay for selected resources. Payment entry page 1102 is first displayed. Payment entry page 1102 is configured to enable a user to input payment information. Payment entry page 1102 may be configured to receive any number of payment types. For instance, payment entry page 1102 may enable a user to pay for selected resources using a credit card (by submitting credit card information), using a bank account (by inputting of bank account information for direct withdrawal), using wire transfer, by cell phone account (by providing a phone number or other cell phone account information), or using other type of payment information.

In step 1006, a payment indication is received from the user in the payment interface. For instance, upon completion of payment entry page 1102, payment review page 1104 may be displayed. Payment review page 1104 displays the selected resources and payment information, and enables the user to review and confirm whether the displayed information is correct. If the user desires to make a correction/change, the user may do so, such as by being returned to bundle selection interface 902 (step 1002) or by being returned to payment entry page 1102. If the user is satisfied with the displayed information, the user may select a “submit purchase” button or other user interface element, and payment receipt page 1106 may be displayed. Payment receipt page 1106 may indicate to the user whether payment was successfully received, and if so, may indicate the purchased subscriptions to the user in the form of a payment confirmation receipt. Upon submission of the purchase, payment interface 904 receives payment from the user for the selected resource(s) according to the particular payment type that was used. Furthermore, a subscription entry may be made to subscription(s) 516 in user account 512 of the user to indicate the purchased resource subscription (e.g., by identifying the purchased resource, a number of purchased accesses, and/or other subscription information).

As shown in FIG. 4, operation proceeds from step 412 (e.g., from step 1006) to step 414. In step 414, the application is authorized to use the resource. For example, if authorization interface module 502 determines that the user has delegated authorization to application 110 to use resource 114, in part by the user being registered with resource repository 106 (steps 404 and 406 of flowchart 400) and by the user having a subscription for resource 114 (steps 410 and 412 of flowchart 400), authorization interface module 502 may provide an indication that application 110 is authorized to access resource 114. For instance, as shown in FIG. 1, resource authorization system 112 may transmit an authorization indication 118 to be received by application 110. Authorization indication 118 indicates to application 110 that resource 114 may be accessed. As described elsewhere herein, resource 114 may include data (e.g., a dataset) or other type of resource. Subsequent to this authorization, as described above, application 110 may receive resource 114 from resource repository 106 for use in any manner.

In step 416, the user is navigated back to the application. For example, in an embodiment, in response to receiving authorization indication 118, application 110 may navigate from displaying authorization interface 606 to displaying an interface associated with application 110, which may be another web page or other displayed window. In other embodiments, the user may be returned back to the application in other ways (e.g., closing a window that was opened and included an authorization interface, etc.). Application 110 may continue operation (e.g., from being suspended), and may use resource 114 as desired.

As such, in embodiments, application 110 is delegated authorization by a user to use resource 114 (and optionally further resources of resource repository 106). As described above, resource authorization system 112 determines what resources the developer indicated that may be used by application 110. Resource authorization system 112 may authenticate the user to determine if the user has an account associated with resource repository 16. If not, the user is enable to create such an account. Resource authorization system 112 then determines if the user has subscriptions to the indicated resources, or if the user wants to purchase any of the subscriptions that they do not have. The user may complete a purchase flow for the subscriptions. The user is then navigated back to the application where they can use the data in application 110.

For instance, in one example provided for purposes of illustration, an application (e.g., Microsoft Excel®, etc.) that is external/separate from the resource repository may be configured to provide an application pre-page (e.g., a button indicating “Sign In”). A sign in process to a user account (e.g., a Windows Live ID, etc.) is provided. Whether the user has a resource repository account or registration associated with the user account is determined For instance, Windows Azure™ Marketplace DataMarket provided by Microsoft Corporation of Redmond, Washington, is one example of a resource repository, where subscriptions to various types of data provided from various sources may be obtained. If the user does not have an account/registration with the resource repository, the user is enabled to register for an account. If the user has an existing login account (e.g., Windows Live ID), the user may be enabled to use the existing login account, and the registration with the resource repository may be associated with the login account.

If the user does have a resource repository account, or after the user establishes the resource repository account, it is determined whether the application needs full account access. If the application needs full account access, the user may grant the application full access to the account. If the application does not need full account access, it may be determined whether the user already has a subscription to offered data sets within one or more bundles. If the user does not already have a subscription to offered data sets within the bundle(s), a bundle is selected (e.g., a default bundle, a customized bundle, etc.). If the user does already have a subscription to offered data sets within the bundle(s), but a price for the bundle has been changed or adjusted, a bundle may be selected in a price adjusted manner. In either case, the user selects a bundle.

A payment page is provided. Any necessary error handling may be performed with regard to the payment page. The page is reviewed, and a receipt is generated. After this, operations proceed back to the external application.

### III Example Computing Device Embodiments

Resource authorization system 112, data service 122, application registration module 202, authorization interface module 502, user registration module 504, resource determiner 506, subscription purchasing module 508, flowchart 300, flowchart 400, flowchart 800, and flowchart 1000 may be implemented in hardware, software, firmware, or any combination thereof For example, resource authorization system 112, data service 122, application registration module 202, authorization interface module 502, user registration module 504, resource determiner 506, subscription purchasing module 508, flowchart 300, flowchart 400, flowchart 800, and/or flowchart 1000 may be implemented as computer program code configured to be executed in one or more processors. Alternatively, resource authorization system 112, data service 122, application registration module 202, authorization interface module 502, user registration module 504, resource determiner 506, subscription purchasing module 508, flowchart 300, flowchart 400, flowchart 800, and/or flowchart 1000 may be implemented as hardware logic/electrical circuitry. For instance, in an embodiment, one or more of resource authorization system 112, data service 122, application registration module 202, authorization interface module 502, user registration module 504, resource determiner 506, subscription purchasing module 508, flowchart 300, flowchart 400, flowchart 800, and/or flowchart 1000 may be implemented in a system-on-chip (SoC). The SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

As described above, resource authorization system 112 may generate one or more user interfaces (e.g., authorization interface 606). For instance, resource authorization system 112 may enable user input to be provided from one or more of any type of user interface elements provided by computing device 102, including a keyboard, a thumb wheel, a pointing device, a roller ball, a stick pointer, a touch sensitive display, any number of virtual interface elements, a voice recognition system, etc.

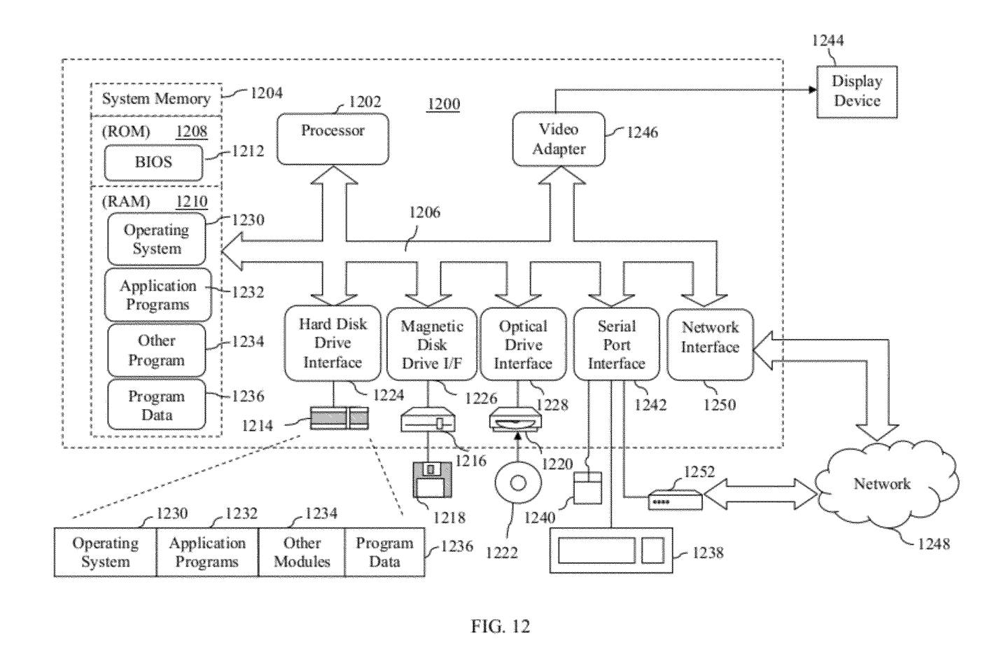

FIG. 12 depicts an exemplary implementation of a computer 1200 in which embodiments of the present invention may be implemented. For example, computing device 102 and/or server 104 may be implemented in a computer system similar to computer 1200, including one or more features of computer 1200 and/or alternative features. Computer 1200 may be a general-purpose computing device in the form of a conventional personal computer, a mobile computer, a server, or a workstation, for example, or computer 1200 may be a special purpose computing device. The description of computer 1200 provided herein is provided for purposes of illustration, and is not intended to be limiting. Embodiments of the present invention may be implemented in further types of computer systems, as would be known to persons skilled in the relevant art(s).

As shown in FIG. 12, computer 1200 includes one or more processors 1202, a system memory 1204, and a bus 1206 that couples various system components including system memory 1204 to processor 1202. Bus 1206 represents one or more of any of several types of bus structures, including a memory bus or memory controller, a peripheral bus, an accelerated graphics port, and a processor or local bus using any of a variety of bus architectures. System memory 1204 includes read only memory (ROM) 1208 and random access memory (RAM) 1210. A basic input/output system 1212 (BIOS) is stored in ROM 1208.

Computer 1200 also has one or more of the following drives: a hard disk drive 1214 for reading from and writing to a hard disk, a magnetic disk drive 1216 for reading from or writing to a removable magnetic disk 1218, and an optical disk drive 1220 for reading from or writing to a removable optical disk 1222 such as a CD ROM, DVD ROM, or other optical media. Hard disk drive 1214, magnetic disk drive 1216, and optical disk drive 1220 are connected to bus 1206 by a hard disk drive interface 1224, a magnetic disk drive interface 1226, and an optical drive interface 1228, respectively. The drives and their associated computer-readable media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 1230, one or more application programs 1232, other program modules 1234, and program data 1236. Application programs 1232 or program modules 1234 may include, for example, computer program logic (e.g., computer program code) for implementing resource authorization system 112, data service 122, application registration module 202, authorization interface module 502, user registration module 504, resource determiner 506, subscription purchasing module 508, flowchart 300, flowchart 400, flowchart 800, and/or flowchart 1000 (including any step of flowcharts 300, 400, 800, and 1000), and/or further embodiments described herein.

A user may enter commands and information into the computer 1200 through input devices such as keyboard 1238 and pointing device 1240. Other input devices (not shown) may include a microphone, joystick, game pad, satellite dish, scanner, or the like. These and other input devices are often connected to processor 1202 through a serial port interface 1242 that is coupled to bus 1206, but may be connected by other interfaces, such as a parallel port, game port, or a universal serial bus (USB).

A display device 1244 is also connected to bus 1206 via an interface, such as a video adapter 1246. In addition to the monitor, computer 1200 may include other peripheral output devices (not shown) such as speakers and printers.

Computer 1200 is connected to a network 1248 (e.g., the Internet) through an adaptor or network interface 1250, a modem 1252, or other means for establishing communications over the network. Modem 1252, which may be internal or external, is connected to bus 1206 via serial port interface 1242.

As used herein, the terms “computer program medium,” “computer-readable medium,” and “computer-readable storage medium” are used to generally refer to media such as the hard disk associated with hard disk drive 1214, removable magnetic disk 1218, removable optical disk 1222, as well as other media such as flash memory cards, digital video disks, random access memories (RAMs), read only memories (ROM), and the like. Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

As noted above, computer programs and modules (including application programs 1232 and other program modules 1234) may be stored on the hard disk, magnetic disk, optical disk, ROM, or RAM. Such computer programs may also be received via network interface 1250 or serial port interface 1242. Such computer programs, when executed or loaded by an application, enable computer 1200 to implement features of embodiments of the present invention discussed herein. Accordingly, such computer programs represent controllers of the computer 1200.

The invention is also directed to computer program products comprising software stored on any computer useable medium. Such software, when executed in one or more data processing devices, causes a data processing device(s) to operate as described herein. Embodiments of the present invention employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMs, nanotechnology-based storage devices, and the like.

### VI. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method in a server, comprising:
providing a user of an application with an authorization interface in response to the application determining a need for a resource of a resource repository, the application executing in a computing device separated from the server by a network, the user interacting with the application at the computing device;
determining whether the user is registered with the resource repository;
enabling the user to register with the resource repository if the user is determined to not be registered with the resource repository;
determining a resource available at the resource repository designated to be used in the application;
determining whether the user has a subscription to the resource;
enabling the user to purchase a subscription to the resource if the user is determined to not have a subscription to the resource; and
authorizing the application to use the resource;
the user being returned to the application, the application being enabled to use the resource associated with the subscription.

2. The method of claim 1, wherein said providing a user of an application with an authorization interface in response to the application determining a need for a resource of a resource repository comprises:
generating a user consent uniform resource locator (URL) that is navigated in response to the application determining a need for a resource of the resource repository.

3. The method of claim 1, wherein said determining whether the user is registered with the resource repository comprises:
providing a sign in interface that enables the user to sign into a user account;
identifying the user based on the user account; and
determining that a registration with the resource repository is not associated with the user account.

4. The method of claim 1, wherein said enabling the user to register with the resource repository if the user is determined to not be registered with the resource repository comprises:
enabling the user to sign up for a user account associated with the resource repository if the user does not have the user account.

5. The method of claim 1, further comprising:
if the user is determined to have a subscription to the resource, determining whether a price for the resource has been adjusted.

6. The method of claim 1, wherein said enabling the user to purchase a subscription to the resource if the user is determined to not have a subscription to the resource comprises:
enabling the user to select a bundle associated with the resource;
providing a payment interface; and
receiving a payment indication from the user in the payment interface.

7. The method of claim 6, wherein said providing a payment user interface comprises:
providing a sequence of user interface pages including a payment entry page, a payment review page, and a payment receipt page.

8. The method of claim 1, wherein the resource is a dataset.

9. A resource authorization system in a server, comprising:
an authorization interface module that provides a user of an application with an authorization interface in response to the application determining a need for a resource of a resource repository, the application executing in a computing device separated from the server by a network, the user interacting with the application at the computing device;
a user registration module that enables the user to register with the resource repository if the user is determined to not be registered with the resource repository;
a resource determiner that determines a resource available at the resource repository designated to be used in the application; and
a subscription purchasing module that enables the user to purchase a subscription to the resource if the user is determined to not have a subscription to the resource;
wherein the authorization interface module authorizes the application to use the subscribed resource and enables the user to be returned back to the application, the application being enabled to use the subscribed resource.

10. The resource authorization system of claim 9, wherein the authorization interface module generates a user consent uniform resource locator (URL) that is navigated in response to the application determining a need for a resource of the resource repository.

11. The resource authorization system of claim 9, wherein the user registration module is configured to provide a sign in interface that enables the user to sign into a user account, to identify the user based on the user account, and to determine whether a registration with the resource repository is associated with the user account.

12. The resource authorization system of claim 9, wherein the user registration module enables the user to sign up for a user account associated with the resource repository if the user does not have the user account.

13. The resource authorization system of claim 9, wherein the subscription purchasing module determines whether a price for the resource has been adjusted if the user is determined to have a subscription to the resource.

14. The resource authorization system of claim 9, wherein if the user is determined to not have a subscription to the resource, the subscription purchasing module enables the user to select a bundle associated with the resource, provides a payment interface, and receives a payment indication from the user in the payment interface.

15. The resource authorization system of claim 14, wherein the subscription purchasing module provides a sequence of user interface pages including a payment entry page, a payment review page, and a payment receipt page.

16. The resource authorization system of claim 9, wherein the resource is a dataset.

17. A method, comprising:
enabling a developer to register an application with a resource repository; and
enabling the developer to designate a resource at the resource repository to be used in the application;
the application being configured to provide a user interface associated with the resource repository that enables a user to purchase a subscription to the designated resource of the resource repository.

18. The method of claim 17, comprising:
enabling the developer to receive compensation when a user using the application purchases a subscription to the designated resource for use by the application.
